(19) United States
(12) Patent Application Publication
(10) Pub. No.: US 2007/0096546 A1
(43) Pub. Date: May 3, 2007

(54) Device attachment to a center hub of a wheel

(76) Inventors: Mark Thomas, Cupertino, CA (US); Joel Osias, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/263,757

(22) Filed: Oct. 31, 2005

(51) Int. Cl. B60B 27/00

(52) U.S. Cl. 301/108.5

(57) ABSTRACT

A method and apparatus for attaching wheels to a vehicle in a manner that provides a platform for attaching additional devices. The additional device is attached in a manner that maintains minimal axial extension of the wheel.

### FIELD OF INVENTION

The field of invention relates generally to attaching a device to a wheel of a vehicle. In particular, the invention relates to attaching a device to a wheel that is attached to a hub of an axle using a “knock off” nut.

### BACKGROUND

In the automotive industry, typically a wheel is manufactured to be attached to a hub of a vehicle axle in one of two ways—by way of a number of lug nuts or by way of a single central “knock-off” nut.

A wheel is attached to a hub using a knock off nut as follows. First, if the hub does not already have an integral cylindrical male threaded center extension, an adapter is attached to the axle hub. This adapter consists of a flanged male threaded center extension. The flange has holes matching the lug pattern of the hub, thus allowing attachment to the hub via lug nuts. For example, lugs on the axle hub are mated with holes in the adapter, and lug nuts are fastened to the lugs to fix the adapter to the axle hub. Next, a wheel is slid onto the cylindrical male threaded center extension until fully seated. A hole in the center of the wheel accommodates the cylindrical male threaded center extension. A knockoff nut is then engaged to the threads of the cylindrical male threaded center extension and tightened to secure the wheel to the hub.

There are many forms of knockoff nuts in the prior art, however, they all include an open end with a circular female threaded portion to engage the male threads of the adapter, and a closed end that forms a cap for the hub to which the wheel is held by the knock off nut. What is needed is a knock off nut that provides for the ability to attach a device to a wheel in a manner than minimizes the axial extension of the wheel or the hub to which it is attached.

### SUMMARY

A knock off nut includes a cylinder. The cylinder may include a female-threaded inner surface to engage an adapter for mounting a wheel to a hub of an axle. At one end of the cylinder is a platform to which to couple an attachment to the knock off nut.

### BRIEF DESCRIPTION OF THE DRAWINGS

A better understanding of the present invention can be obtained from the following detailed description in conjunction with the following drawings, in which:

FIG. 1 illustrates an embodiment of the invention.

FIG. 2 illustrates an embodiment of the invention.

FIG. 3 illustrates an embodiment of the invention.

FIG. 4 illustrates a tool that may be used to attach or remove a knock off nut in accordance with an embodiment of the invention.

FIG. 5 illustrates attachment of a device to a knock off nut in accord with an embodiment of the invention.

FIG. 6 illustrates attachment of a device to a knock off nut in accord with an embodiment of the invention.

FIG. 7 illustrates attachment of a device to a knock off nut in accord with an embodiment of the invention.

### DETAILED DESCRIPTION

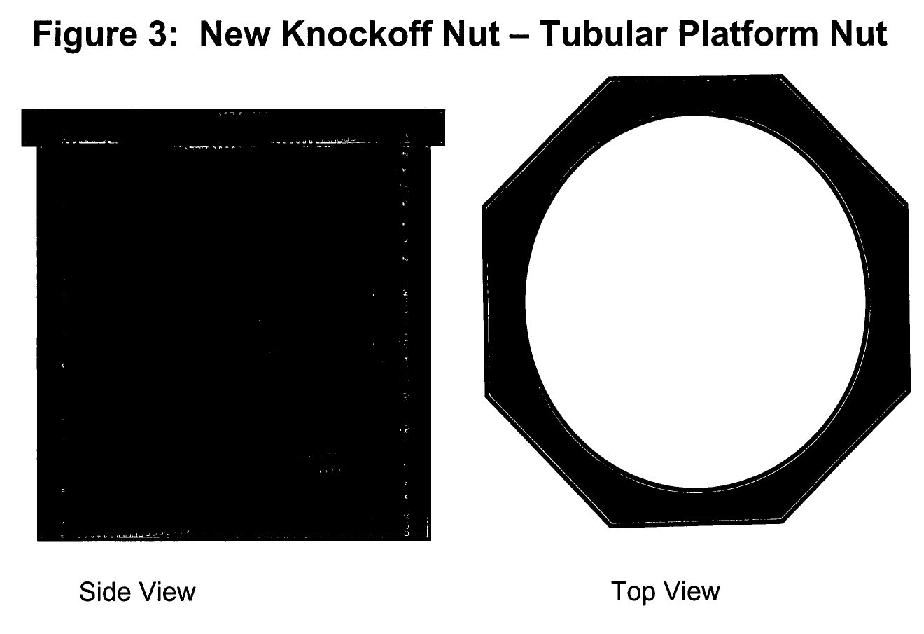

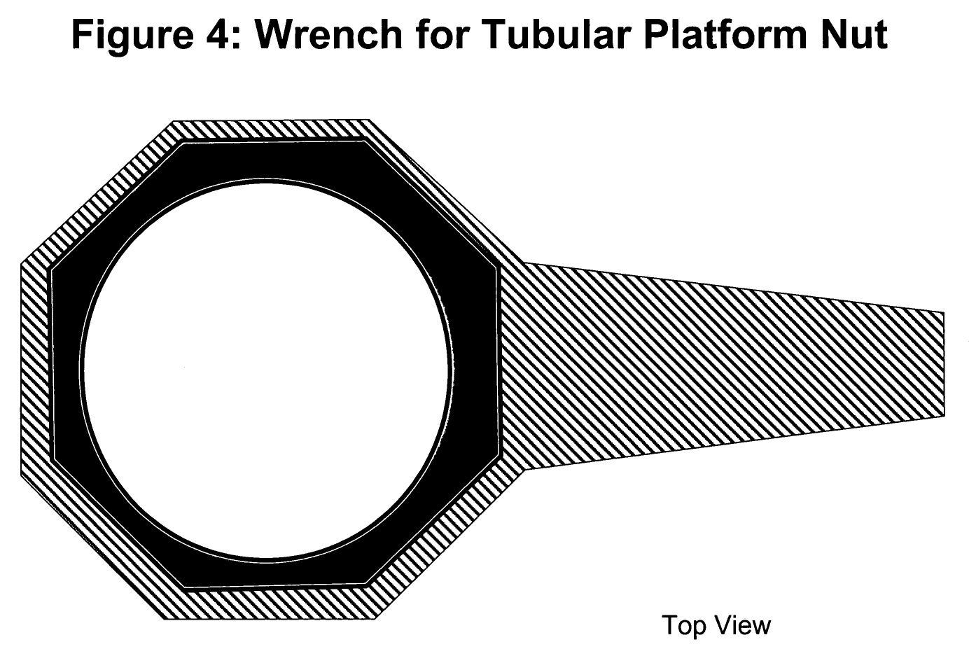

The invention contemplates an improved knockoff nut, also referred to herein as a tubular platform nut. The tubular platform nut differs from a standard knockoff nut in that it is open at both ends, as is seen in the top view illustrated in FIG. 3. The tubular platform nut includes a section that allows it to be tightened by an appropriate tool. For example, in FIG. 4, an octagonal shaped portion at one end of the tubular platform nut allows for tightening or un-tightening of the nut against a wheel using a wrench tool. The tubular platform nut includes a circular female threaded portion (shown in the transparent side view of FIG. 3) that engages the cylindrical male threaded center extension of a hub adapter.

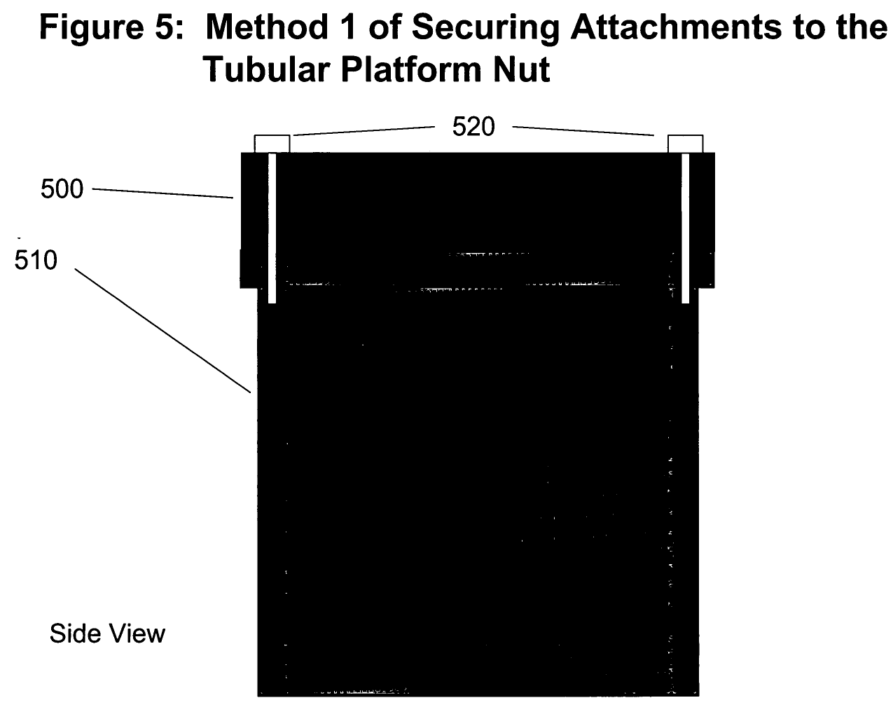

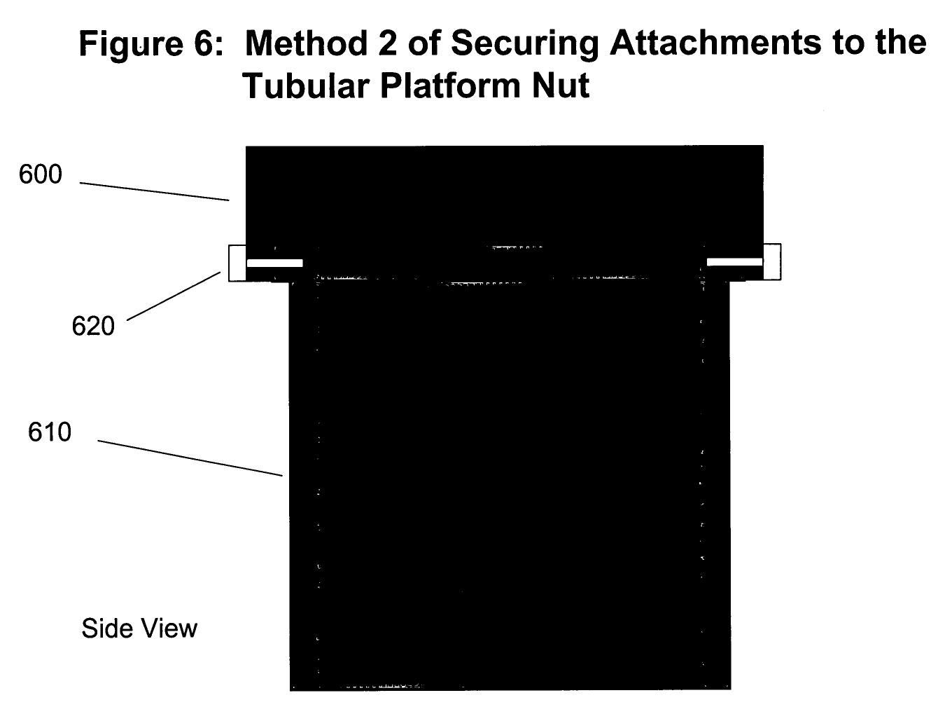

The tubular platform nut, as its name implies, further provides a platform for securing or mounting attachments to the tubular platform nut, and hence, the wheel that also is secured by the tubular platform nut. The term platform refers to the capability of the nut to act as a platform to mount additional structures or attachments. There are a variety of ways such attachments can be fixed to the tubular platform nut. For example in FIG. 5 an attachment (500) is secured to the tubular platform nut (510) by a set of screws (520) that are axially oriented. Alternatively, an attachment is secured as shown in FIG. 6, wherein a set of radially oriented screws (620) secures an attachment (600) to the nut (610). Other means of securing an attachment to the tubular platform nut may be contemplated by those skilled in the art. For example, the attachment 500 may have a cylindrical male threaded center extension that engages the inner circular female treaded portion of the tubular platform nut, and may have a portion shaped just like the octagonal shaped portion at one end of the tubular platform nut to allow for tightening or un-tightening of the attachment to the nut in the same manner and using the same tool as used to tighten the nut against a wheel, using the above described wrench tool.

There are a number of advantages to the invention, including, for example, the use of the outer surface of the tubular platform nut to attach a variety of end caps to change the aesthetic look of the nut without the cost or time involved to purchase and install a separate knock off nut for each aesthetic look. This separation of the end cap from the tubular platform nut allows ready interchange of knockoff nut caps without disturbing the wheel attachment interface. To those knowledgeable in the use of knockoff wheels, it is well know that wheel attachment interface requires considerable care and should not be disturbed unnecessarily. For example, removing and subsequently reinstalling a knockoff nut of any variety requires the user to pay careful attention after installation for a period of several hours of use of a vehicle to which the wheel is attached. The user must retighten the nut with the appropriate torque to ensure the knockoff nut does not become loose. In addition, while removing a knockoff nut, a vehicle's weight must continue to be supported, in the event the wheel falls off during the time the nut is removed.

Further, the tubular geometry significantly decreases machining time for a knock off nut, and reduces material costs by allowing usage of tubular bar stock, as opposed to solid round bar stock, which otherwise requires hogging out at the open end of the solid round bar stock.

Yet another advantage of the invention is access to the inner cylindrical volume of the adapter's male threaded center extension between the end of the axle and the outside end of the extension. Any number of devices may be housed in this space, for example, devices that sense, for example, temperature, pressure, or vibration, or devices that transmit or receive light waves, sound waves, or electrical signals, and/or devices that perform computations based thereon.

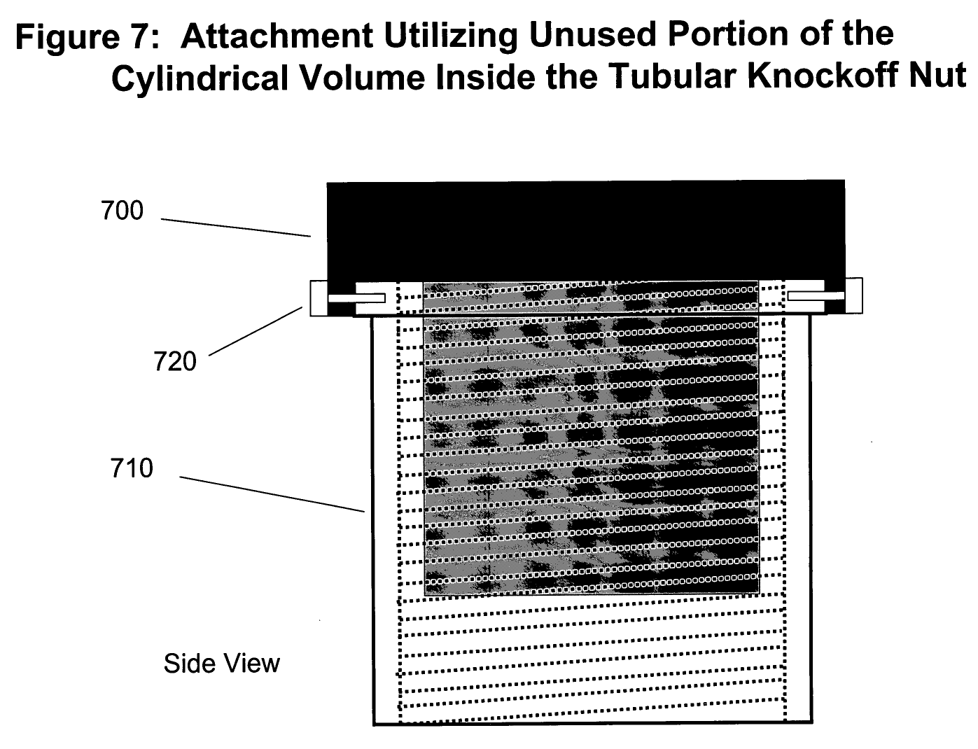

FIG. 7 illustrates an embodiment of the invention, wherein a portion of the attachment 700 extends into the cylindrical volume 710. This is advantageous if it is desired to attach to the hub a device of a size and/or shape that can make use of this volume in performing one or more optical, mechanical, and/or electrical functions. Importantly, the device, and the additional functionality provided by the device, may be attached to the hub in this manner without substantially changing the aesthetics and size of wheel/nut combination.

For example, the axial displacement of the wheel/nut combination may be less than in the case where the end of the nut was closed, as in the prior art, wherein the unused space of the inner cylindrical volume of the adapter's male threaded center extension was not available to house the added functionality. In the prior art, a device attached to provide this added functionality would necessarily extend the axial dimensions to accommodate the device.

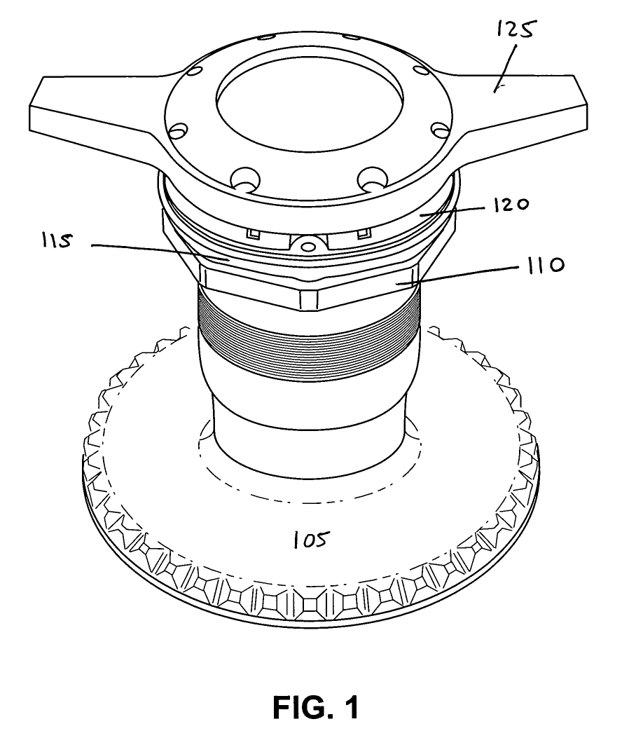

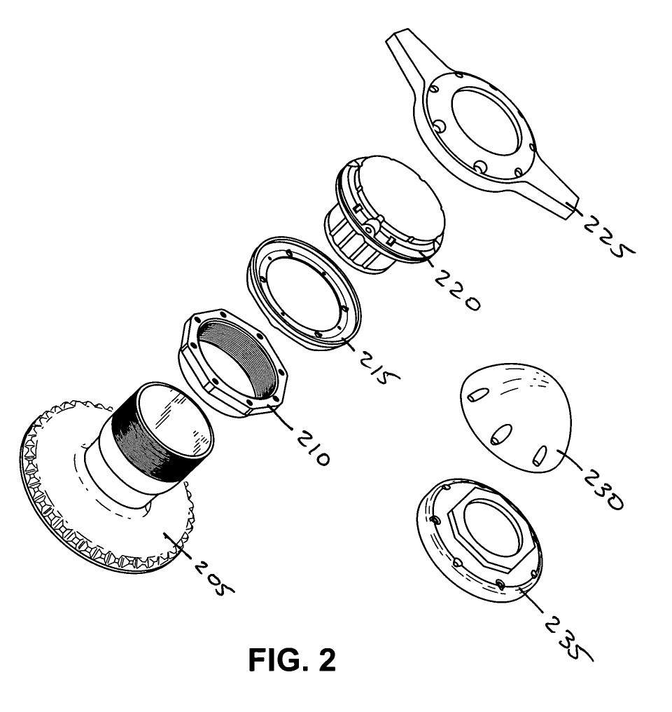

More specifically, and with reference to FIGS. 1 and 2, consider the case wherein the attachment is a Wheel Illumination Device (WID) 220. One of the components of the WID may be a battery pack. In accordance with the invention, it is possible in one embodiment to locate the battery pack in the adapter's cylindrical male threaded center extension. In another embodiment, the adapter's integral cylindrical male threaded center extension may house a generator to either charge the aforementioned batteries and/or directly act as a power supply for circuitry in the WID.

FIGS. 1 and 2 illustrate the adapter 105, 205 that supports a wheel (not shown). The wheel is guided over the adapter via a center hole in the wheel. The open-ended tubular platform nut 110, 210 is then attached to the adapter, for example, by mating female threads on the inner cylinder of the nut to the male threads on the outer surface of the cylindrical extension of the adapter. A device, for example, a wheel illumination device (WID) 120, 220, is set into the opening provided by the combination of the adapter and tubular platform nut. In one embodiment, an end cap 125, 225 is placed over top of the WID 120, 220 and screws inserted through openings in the end cap are threaded through threaded holes in the tubular platform nut to affix the WID to the adapter.

Given that end cap 125, 225 is separate from WID 220, it may be easily exchanged with other end caps, e.g., 230 or 235 to change the aesthetic look of the wheel. In another embodiment, the end cap may be integrated with the WID, or openings provided in the WID may receive screws to be threaded through the threaded holes in the tubular platform nut to affix the WID to the adapter.

In alternative embodiments, an outside cylindrical surface of the WID may include a male threaded portion that engages the cylindrical female-threaded portion of the tubular platform nut. Other means, such as clamps, or hinges and clasps may be used to attach the WID to the tubular platform nut without departing from the invention.

In one embodiment of the invention, WID provides illumination of the wheel to which the tubular nut platform and WID is attached. The light may be provided by one or more sources of light, e.g., one or more light-emitting-diodes, housed in the WID. In one embodiment, the light sources provide the same color light, e.g., a white light. A transparent, colored, filter 115, 215, may be placed over the WID as shown in FIGS. 1 and 2 to change the color of light that actually illuminates the wheel. Use of a color filter 115, 215 provides for the ability to install one of any number of different colored filters at the time of installation of the WID, thereby saving cost and time associated with purchasing and installing different WIDs to produce different colors of light.

What is claimed is:

1. A knock off nut, comprising:
a cylinder having a female-threaded inner surface to engage an adapter for mounting a wheel to a hub of an axle; and
a platform at one end of the cylinder to which to couple an attachment to the knock off nut.

2. The knock off nut of claim 1, wherein the attachment is an end cap.

3. The knock off nut of claim 1, further comprising an opening at the one end to house at least partially the attachment.

4. The knock off nut of claim 1, wherein the attachment comprises a wheel illumination device.

5. The knock off nut of claim 4, herein the attachment further comprises an end cap.

6. The knock off nut of claim 1, wherein the attachment is a device selected from a group of devices that sense one or more of temperature, pressure, and vibration, and/or that transmit and/or receive light waves, sound waves, or electrical signals, and/or that perform computations based on one or more thereon.
